(19) United States
(12) Patent Application Publication
(10) Pub. No.: US 2009/0077872 A1
(43) Pub. Date: Mar. 26, 2009

(54) System and Apparatus for Preventing Freezing of Crops

(76) Inventors: Lawrence E. Faria, Kingston, NH (US); Emmanuel J. Perrotti, Ramsey, NJ (US); David R. Sar, Corona, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/238,542

(22) Filed: Sep. 26, 2008

Related U.S. Application Data
(60) Provisional application No. 60/975,306, filed on Sep. 26, 2007.

(51) Int. Cl. H05B 6/80; A01G 13/06; H05B 6/72; H01Q 1/44

(52) U.S. Cl. 47/2; 219/748

(57) ABSTRACT

A system for preventing freezing of crops within a volume includes a plurality of RF radiators configured to radiate RF energy into the volume. A height, a spacing, an output power, a vertical beam angle, a vertical beam width, and a horizontal beam width of each one of the plurality of RF radiators is selected to result in an average RF power density taken about three dimensions within the volume sufficient to prevent freezing of a substantial portion of the crops, and also to result in a peak-to-peak variation of RF power density taken about two dimensions in a horizontal plane within the volume and at heights below a predetermined height to be less than a predetermined percentage of an average RF power density taken about the two dimensions.

### CROSS REFERENCE TO RELATED APPLICATIONS

This application claims the benefit under 35 U.S.C. §119(e) of U.S. Provisional Application No. 60/975,306 filed Sep. 26, 2007, which application is incorporated herein by reference in its entirety.

### FIELD OF THE INVENTION

This invention relates generally to radio frequency (RF) systems and apparatus and, more particularly, to an RF system and apparatus that can be used to prevent frost damage to various tree, vine, vegetable and other crops.

### BACKGROUND OF THE INVENTION

Damage of crops due to freezing temperatures is known to cause a large loss of revenue to growers. For example, in California alone, during January 2007, citrus growers lost more than eight hundred million dollars as a result of prolonged freezing temperatures. Other crops also suffered during January 2007, including avocados, strawberries, spring vegetables and artichokes. California state officials estimated that during January 2007, total losses from the freeze totaled more than one billion dollars. Others states, notably Washington, Oregon, Florida and Texas, as well as many countries in temperate zones, are also subject to freezing temperatures and resulting risk to crops and crop loss.

Some frost prevention techniques are used to prevent frost damage to crops. For example, one frost prevention technique employs fans on towers, which are above the crops and at a height sufficient to pull heat from a warmer inversion layer that is known to form at some height above the crops during certain types of freeze events. The fans are at fixed locations. The effectiveness of this technique is limited by the inversion layer being only slightly warmer than the temperature at the height of the crops.

Another frost prevention technique employs water at a temperature above freezing, which is sprayed onto the crops. Both the sensible heat available from the warmer temperature of the water and also the latent heat of crystallization (extra energy) required for freezing the water contribute to the frost prevention. The effectiveness of this technique is limited in that the energy available to the crop is only that stored in the water, which defines the temperature and duration at which the method is effective. Once the stored energy has been released, no more warming is available.

Another frost prevention technique employs stoves or heat generators positioned under the crops. This technique suffers from very low efficiency and high fuel cost, and tends to degrade in performance in the presence of wind.

A known frost prevention system is described in U.S. Pat. No. 4,434,345. This system employs microwaves to heat crops. However, the microwaves are transmitted by an antenna, which must generally be moved about a crop field in order to irradiate the crops. The resulting irradiation field strength is not sufficiently uniform to effectively prevent damage to crops.

### SUMMARY OF THE INVENTION

The present invention provides an RF field that is substantially uniform over an entire crop. The RF power density can be tailored to allow humans and other animals to move about safely in the field even while the crops are being irradiated.

In accordance with one aspect of the present invention, a system for preventing freezing of crops within a volume includes a plurality of RF radiators configured to radiate RF energy into the volume, the RF energy having an RF frequency substantially absorbed by water. Each one of the plurality of RF radiators has a respective beampattern with a respective vertical beam angle, a respective vertical beam width, and a respective horizontal beam width. A respective height, a respective spacing, a respective output power, the respective vertical beam angle, the respective vertical beam width, and the respective horizontal beam width of each one of the plurality of RF radiators is selected to result in an average RF power density taken about three dimensions within the volume sufficient to prevent freezing of a substantial portion of the crops, and also to result in a peak-to-peak variation of RF power density taken about two dimensions in a horizontal plane within the volume and at heights below a predetermined height to be less than a predetermined percentage of an average RF power density taken about the two dimensions, and also to result in positive peaks of the peak-to-peak variation of the RF power density taken about the two dimensions at the heights below the predetermined height to have a magnitude below a safe level for human exposure.

In accordance with another aspect of the present invention, a method of warming crops within a volume includes irradiating the volume with RF energy, the RF energy having an RF frequency substantially absorbed by water, to result in an average RF power density taken about three dimensions within the volume sufficient to prevent freezing of a substantial portion of the crops, and also to result in a peak-to-peak variation of RF power density taken about two dimensions in a horizontal plane within the volume and at heights below a predetermined height to be less than a predetermined percentage of an average RF power density taken about the two dimensions, and also to result in positive peaks of the peak-to-peak variation of the RF power density taken about the two dimensions at the heights below the predetermined height to have a magnitude below a safe level for human exposure.

In accordance with another aspect of the present invention, a computer-readable storage medium having computer readable code thereon for warming crops within a volume includes instructions for receiving one or more environmental signals, and instructions for generating a control signal to adjust a power of an RF signal in accordance with the one or more environmental signals.

### BRIEF DESCRIPTION OF THE DRAWINGS

The foregoing features of the invention, as well as the invention itself may be more fully understood from the following detailed description of the drawings, in which:

FIG. 1 is a graph showing a variety of measured data taken in California;

FIG. 2 is a pictorial showing a plurality of radio frequency (RF) radiators dispersed among a plurality of crop trees, e.g., citrus fruit trees;

FIG. 2A is a block diagram showing environmental sensors, a power calculation module, and an RF transmitter that can be used to drive the plurality of RF radiators of FIG. 2;

FIG. 3 is a graph showing an exemplary vertical beam pattern of one of the RF radiators of FIG. 2;

FIG. 4 is a graph showing an exemplary horizontal beam pattern of the RF radiator of FIG. 3;

FIG. 5 is a graph showing an exemplary vertical beam pattern of another embodiment of one of the RF radiators of FIG. 2;

FIG. 6 is a graph showing an exemplary horizontal beam pattern of the RF radiator of FIG. 5;

FIG. 7 is graph indicative of top view of an exemplary system having four RF radiators per acre showing exemplary RF field strengths versus horizontal position in two dimensions;

FIG. 8 is a graph indicative of a side view of a part the system of FIG. 7 showing exemplary RF field strengths versus height and also versus horizontal position in one dimension; and

FIG. 9 is a graph indicative of behavior of the system of FIG. 2A when the heating capability of the system cannot keep up with the rate of temperature drop of the ambient temperature.

### DETAILED DESCRIPTION OF THE INVENTION

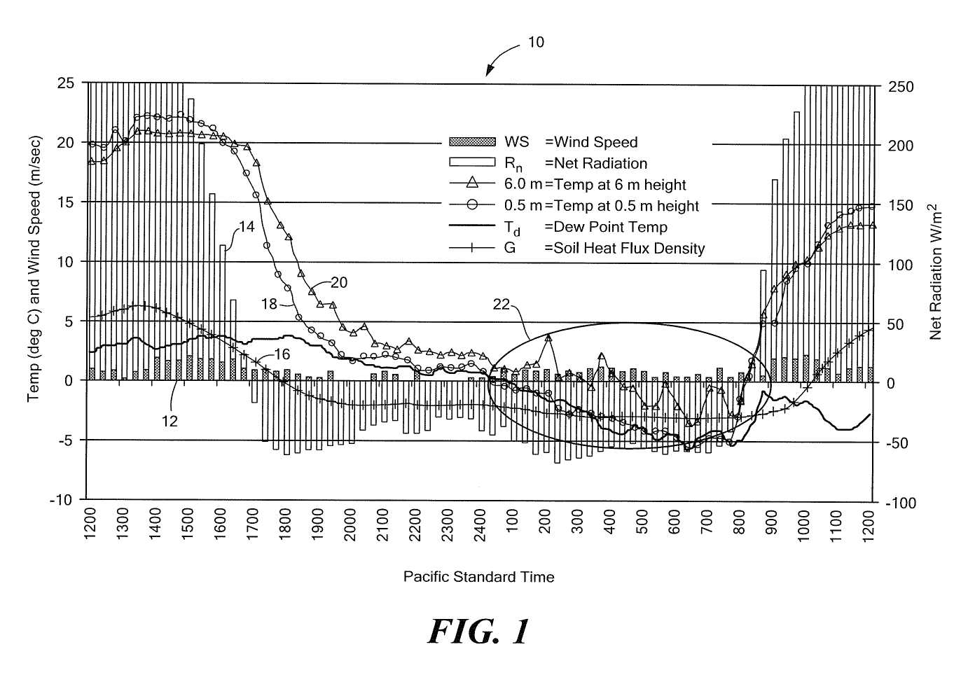

Referring to FIG. 1, a graph 10 includes a left-side vertical axis having units of both temperature in degrees Celsius and also wind speed in meters per second. The graph 10 also includes a right-side vertical axis having units of net heat radiation in watts per square meter. The graph 10 also includes a horizontal axis having units of time spanning twenty-four hours.

The graph has bars and curves representative of data taken in February of 2001 at a location in California, as provided by Principles of Frost Protection, Richard L. Snyder, U C Davis, November 2001. The data represents a typical radiation freeze event affecting citrus crops. Dark bars, of which a bar 12 is representative, are indicative of wind speed. Light bars, of which a bar 14 is representative, are indicative of net heat radiation, where negative values are indicative of heat loss and positive values are indicative of heat gain.

A curve 16 is indicative of soil heat flux density. A curve 18 is indicative of temperature and a height of 0.5 meters above the ground. A curve 20 is indicative of temperature six meters above the ground. During a time period bounded by an oval 22, the temperature at 0.5 meters is below freezing.

From the graph 10, an exemplary calculation of energy density required to keep the crops above freezing during the time period represented by the oval 22 can be made, as is summarized in Table 1.

TABLE 1

| | Flux Density |
|---|---|
| | Watts per square |
| Energy Transfer | meter |
| Conduction (from the soil) | +28 |
| Convection (from the air) | +39 |
| Downward Radiation (from the sky) | +230 |
| Upward Radiation (from the orchard) | −315 |
| Net Energy Loss from the crop | −18 |

This calculation shows that, for the example represented by the graph 10, a power density (average) of eighteen watts per square meter could keep the crops above freezing during the time period represented by the oval 22.

While an power density of eighteen watts per square meter may be desirable for the one time period represented by the oval 22, at one location in California, it should be recognized that other higher or lower power densities may be useful at other places at other times to keep crops from freezing.

The Institute of Electrical and Electronics Engineers (IEEE) has set requirements for safety with regard to RF field power densities. It is known that, at 2.45 GHz, an RF power density of less than eight milliwatts per square centimeter is acceptable for human exposure in controlled areas and an RF power density of less than 1.63 milliwatts per square centimeter is acceptable for human exposure in uncontrolled areas. The above-calculated eighteen watts per square meter is less than two milliwatts per square centimeter, which is acceptable for human exposure in controlled areas and almost acceptable for human exposure in uncontrolled controlled areas.

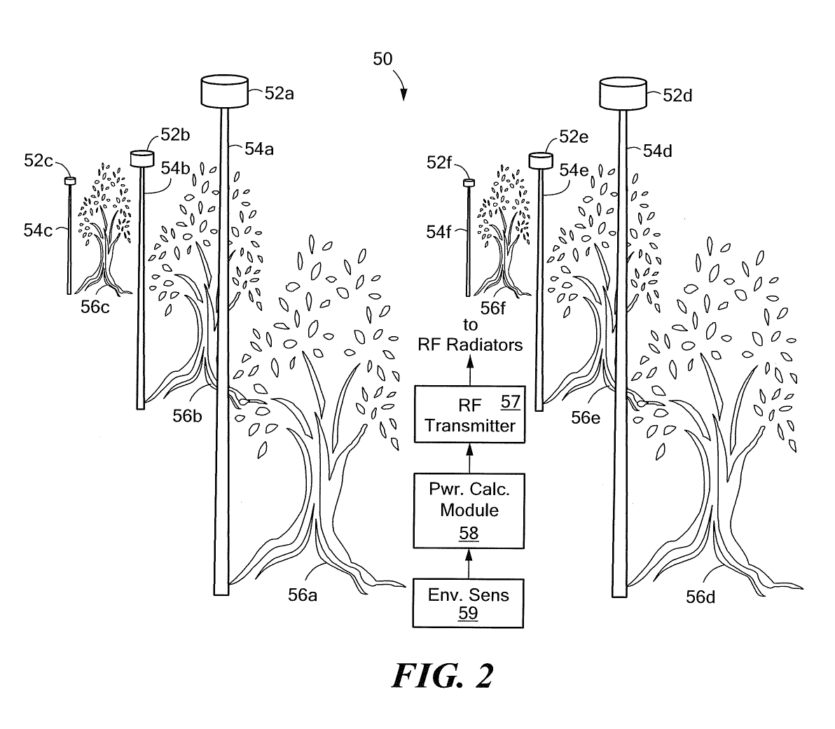

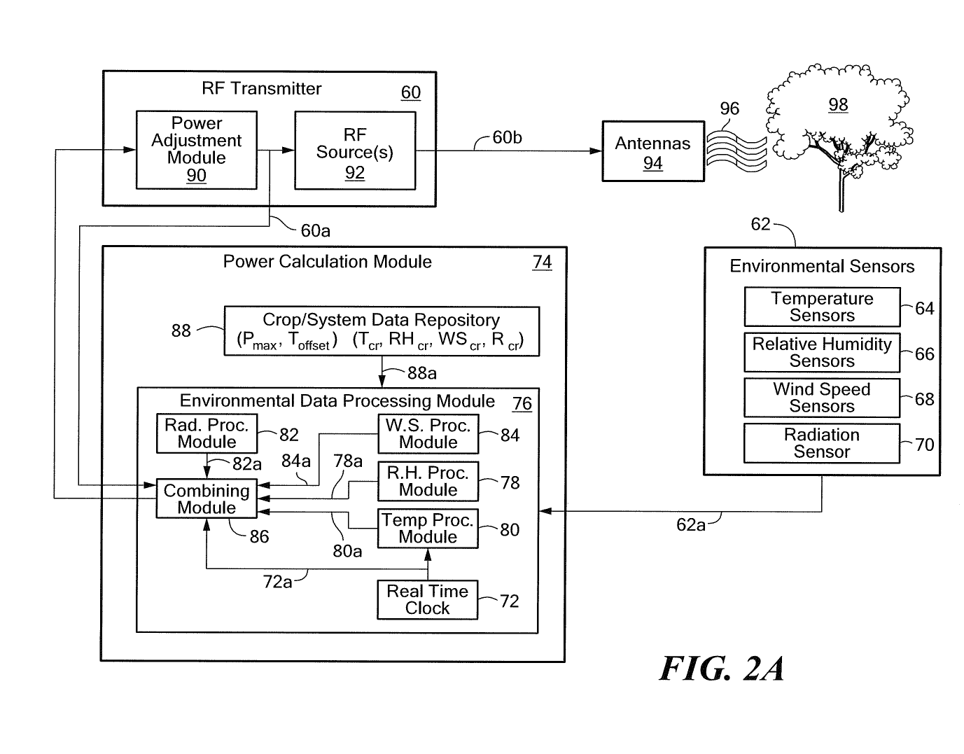

Referring now to FIG. 2, an exemplary system 50 includes a plurality of RF radiators, 52a-52f positioned upon fixed towers 54a-54f at a height above crop trees 56a-56f. In some arrangements, each one of the plurality of RF radiators, 52a-52f can be coupled to and can receive RF power from an RF transmitter 57. An RF power density transmitted by the RF radiators 52a-52f and described more fully below can be adjusted upward or downward by the system 50 according to ambient conditions, for example, ambient temperature at one or more heights above and/or below the ground, and/or wind speed at one or more heights above the ground, and/or relative humidities at one or more heights above the ground, and/or time of day. To this end, a power calculation module 58 can be coupled to the RF transmitter 57 to accomplish this adjustment. The power calculation module 58 can receive inputs from one or more environmental sensors 59.

In one particular arrangement, each one of the RF radiators 52a-52f is configured to transmit into the air RF energy at a frequency in the range of about 2.4 to 2.5 GHz. This frequency range is known to be efficiently absorbed by water-bearing fruit, foliage, and limbs. In other arrangements, each one of the RF radiators 52a-52f is configured to transmit into the air RF energy at a frequency greater than or less than the range of 2.4 to 2.5 GHz.

As is known, the Federal Communications Commission (FCC) regulates emitters of RF energy. The frequency range of 2.4 to 2.5 GHz is within the so-called industrial, scientific, medical (ISM) bands, generally reserved for the purposes implied by the ISM name, and not reserved for communications. Others ISM bands include 6.765 to 6.795 MHz, 13.553 to 13.567 MHz, 26.957 to 27.283 MHz, 40.66 to 44.70 MHz, 433.05 to 434.79 MHz, 902 to 928 MHz, 5.725 to 5.875 GHz, 24 to 24.25 GHz, 61 to 61.5 GHz, 122 to 123 GHz, and 244 to 246 GHz.

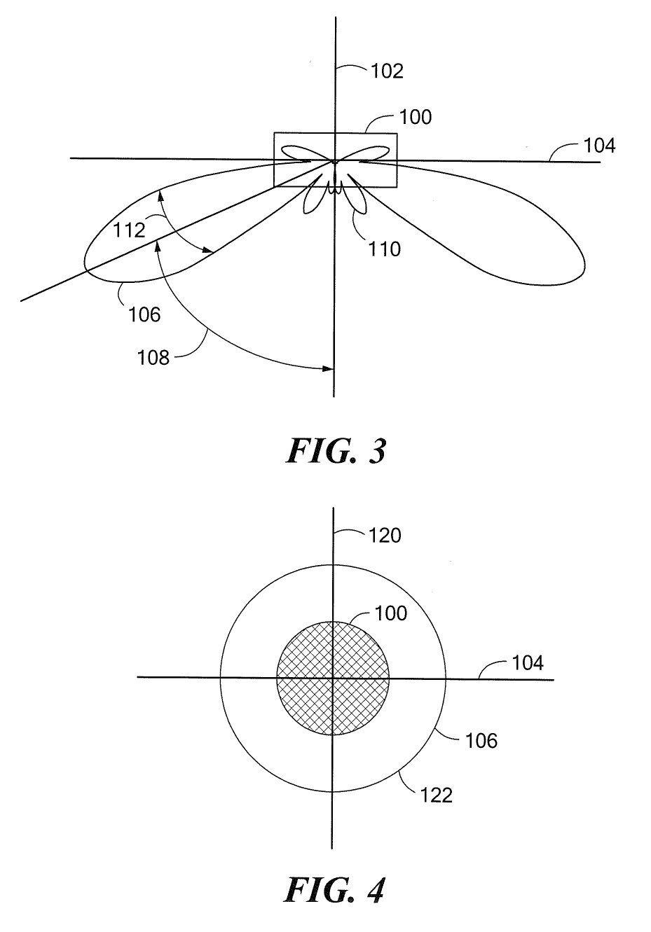

Each one of the RF radiators 52a-52f is configured to transmit the RF energy in a beampattern described more fully below in conjunction with FIGS. 3-6. Each one of the RF radiators 52a-52f can transmit with the same beampattern or with different beampatterns.

While six RF generators 52a-52f and six crop trees 56a-56f are shown, there can be more than six or fewer than six RF radiators 52a-52f. Also, the number of RF radiators 52a-52f need not match the number of citrus tress 56a-56f. Also, in other embodiments, the RF transmitter 58 can provide RF power to more than six or fewer than six RF radiators.

Various types of RF field density uniformities within a volume occupied by the crop trees 56a-56f are described below. It will be appreciated that these uniformities of RF field densities are primarily intended to apply in the case where the volume is empty, i.e., void of the trees, since the crop trees would tend to absorb some of the RF energy. However, in some arrangements, the uniformities of RF field densities described below can also apply to the volume when occupied by the crop trees.

In general, it will be appreciated from discussion below that, a respective height, a respective spacing, a respective output power, a respective vertical beam angle, a respective vertical beam width, and a respective horizontal beam width of each one of the plurality of RF radiators is selected to result in an average RF power density taken about three dimensions within the volume occupied by, or which would be occupied by, the crop trees 56a-56f sufficient to prevent freezing of a substantial portion of the crops, and also to result in a peak-to-peak variation of RF power density taken about two dimensions in a horizontal plane within the volume and at heights below a predetermined height to be less than a predetermined percentage of an average RF power density taken about the two dimensions, and also to result in positive peaks of the peak-to-peak variation of the RF power density taken about the two dimensions at the heights below the predetermined height to have a magnitude below a safe level for human exposure.

In some embodiments, the predetermined height is about six feet and the predetermined percentage is about ten percent. In some embodiments, the average RF power density taken about two dimensions in any horizontal plane within the volume is at least eighteen watts per square meter. In some embodiments, the average RF power density taken about the three dimensions within the volume is at least eighteen watts per square meter.

In some embodiments, the volume spans at least one acre to a height of at least ten feet, or roughly the height or crop trees. However, while crop trees are used as example herein, the system also applies to lower growing crops. In these cases, the volume spans at least one acre to a height of at least three feet.

Furthermore, it will be appreciated from discussion below that below certain heights, for example, at the height of a person walking about the crop trees 56a-56f, a peak RF power density levels deemed to be safe by the IEEE. The safety levels are realized because each one of the RF radiators 52a-52f radiates independently and incoherently from other ones of the RF radiators 52a-52f, eliminating any interferometer effects or coherent addition, which would tend to cause power density peaks.

Referring now to FIG. 2A, an RF transmitter 60 can be the same as or similar to the RF transmitter 58 of FIG. 2, a power calculation module 74 can be the same as or similar to the power calculation module 58 of FIG. 2, and environmental sensors 62 can be the same as or similar to the environmental sensors 59 of FIG. 2.

The power calculation module 74 can be coupled to receive environmental signals 62a from the environmental sensors 62, which can include one or more temperature sensors 64 (which can be in close proximity to or upon the crops, surface temperature sensors, sub-surface temperature sensors, and/or elevated air temperature sensors). In some embodiments, the environmental sensors 62 can also include one or more of relative humidity sensors 66, wind speed sensors 68, or a radiation sensor 70. In response, the power calculation module 74 is configured to generate a power control signal 74a to control the output power of the RF transmitter 60.

The RF transmitter 60 is coupled to receive the power control signal 74a and to generate an RF signal 60b and also a power feedback signal 60a. In operation, the RF signal 60b can have an average power determined according to the power control signal 74a, and therefore, by the environmental signals 62a.

The RF transmitter 60 can include a power adjustment module 90 coupled to receive the power control signal 74a and configured to generate the power feedback signal 60a. The RF transmitter 60 can also include one or more RF sources 92 coupled to receive the power feedback signal 60a and configured to generate the RF signal 60b having a power level in accordance with the power feedback signal 60a.

The RF signal 60b can be received by one or more antennas 94. The antennas 94 can be the same as or similar to one or more of the RF radiators 52a-52f of FIG. 2. In some arrangements, the RF transmitter 60 is coupled to four antennas. However in other embodiments, the RF transmitter 60 is coupled to more than four or fewer than four antennas.

The power calculation module 74 can include an environmental data processing module 76 coupled to receive the environmental signals 62a. In particular, the environmental data processing module 76 can include a temperature processing module 80 coupled to receive signals generated by the temperature sensors 64. In some embodiments, the power calculation module 74 can also include one or more of a relative humidity processing module 78 coupled to receive signals generated by the relative humidity sensors 66, a wind speed processing module 84 coupled to receive signals from the wind speed sensors 68, or a radiation processing module 82 coupled to receive signals from the radiation sensor 70.

In some arrangements, the power calculation module 74 can also include a crop/system data repository 88. The crop/system data repository 88 can hold crop-specific data values associated with particular crops and also data values associated with the system. For example, the crop/system data repository 88 can retain predetermined crop-specific data values corresponding to a critical lowest crop temperature value, T_{crcrop}, or simply T_{cr}. In some embodiments, the crop/system data repository 88 can also retain one or more of predetermined crop-specific data values corresponding to a critical highest relative humidity value, RH_{cr}, predetermined crop-specific data values corresponding to a critical highest wind speed value, WS_{cr}, or predetermined crop-specific data values corresponding to a critical lowest sun radiation value, R_{cr}.

Each critical crop-specific data value can correspond to a particular crop, for example, oranges. Predetermined critical crop-specific data values associated with any number of crops can be retained in the crop/system data repository 88.

The crop/system data repository 88 can also store system values, for example, a heating capability value, Pₘₐₓ, corresponding to a maximum heating capability of the system, for example, in degrees per hour, and also a temperature offset value, T_{offset}, which can be a predetermined minimum offset temperature above the critical lowest crop temperature, T_{cr}, for example, two degrees Celsius above the critical lowest crop temperature value, T_{cr}.

The crop/system data repository 88 can provide the critical lowest crop temperature value, T_{cr}, to the temperature processing module 80 and also the heating capability value, Pₘₐₓ, and the temperature offset value, T_{offset}, all within predetermined data values 88a. In some embodiments, the crop/system data repository 88 can also provide at least one of the critical highest relative humidity value, RH_{cr}, to the relative humidity processing module 78, the critical highest wind speed value, WS_{cr}, to the wind speed processing module 84, or the critical lowest sun radiation value, R_{cr}, to the radiation processing module 82.

The power calculation module 74 can also include a real time clock module 78 configured to generate a real time clock signal 72a received by the temperature processing module 80 and by a combining module 86.

In operation, the environmental processing module 76 can compare a proper crop-specific critical temperature value, T_{cr}, with a current ambient temperature value, Tᵢ, and power the system by a thermostat control accordingly. The ambient temperature, Tᵢ, at which the power control signal 74a becomes indicative of an increase in RF output power can be T_{cr}+T_{offset}, where, as described above, T_{offset} is a predetermined offset temperature selected to turn on RF power at a temperature above T_{cr}.

In some embodiments, the ambient temperature value, Tᵢ, is an average of temperatures reported by a plurality of temperature sensors 64. In other embodiments, the ambient temperature, Tᵢ, is a lowest one of the temperatures reported by the plurality of temperature sensors 64. In other embodiments, there is only one temperature sensor 64 and the ambient temperature is the temperature reported by the one temperature sensor 64.

As described above, in some embodiments, in particular embodiments or situations for which the heating capability of the system is sufficient to overcome the rate of drop of the ambient temperature, the RF output power from the RF source(s) 92 is turned on when Tᵢ=T_{cr}+T_{offset}, as calculated by the temperature processing module 80

In some embodiments, in particular embodiments or situations for which the heating capability of the system is not sufficient to overcome the rate of drop of the ambient temperature, i.e., the temperature is dropping too rapidly, it may be desirable to turn on the RF power sooner. In this case, a different T_{cr}, referred to herein as T_{newer}, can be calculated by the temperature processing module 80, and can be used to turn on the RF power sooner, i.e., at an ambient temperature above Tᵢ=T_{cr}+T_{offset}. The new critical temperature, T_{newer}, is used when the environmental cooling rate exceeds the capability of system in order to mitigate the temperature drop. In that case, heating begins at a time and temperature that will prevent the temperature from falling below T_{cr} before dawn. At dawn, the daylight should reduce the rate of temperature drop and the heating capacity of the system may be able to overcome the rate of drop of the ambient temperature.

In the case where the system heating capability equals or exceeds the environmental cooling rate, then the control relations can be:

$$IF {P}_{max} - \frac{d T}{d {t}_{i}} \geq 0 AND {T}_{i} \leq {T}_{cr} + Δ {T}_{set}$$

THEN turn on RF power at full power (represented by a two state processed temperature signal 80a)
OR turn on RF power at a level in proportion to dT/dtᵢ (represented by proportional processed temperature signal 80a)

However, in the case where the system heating capability is less than the environmental cooling rate, then the control relations can be:

$$IF {P}_{max} - \frac{d T}{d {t}_{i}} \geq 0 AND {T}_{i} \leq {T}_{newer}$$

$$WHERE {T}_{newer} = {T}_{cr} + ( {P}_{max} - \frac{d T}{d {t}_{i}} ) ( {t}_{i} - {t}_{dawn} )$$

THEN turn on RF power at full power (represented by two state processed temperature signal 80a)

### Where:

| | |
|---|---|
| Pₘₐₓ = | system heating capability, deg/hour |
| $\frac{dT}{{dt}_{i}} =$ | rate of change of temperature as measured over a delta t of1 hour, deg/hour |
| T_{cr} = | critical temperature, crop specific |
| T_{offset} = | offset temperature |
| T_{newer} = | calculated critical temperature |
| Tᵢ = | current environmental temperature |
| tᵢ = | current time |
| t_{cr} = | time at critical temperature |
| t_{dawn} = | time at dawn |
| t_{newer} = | time at calculated critical temperature |

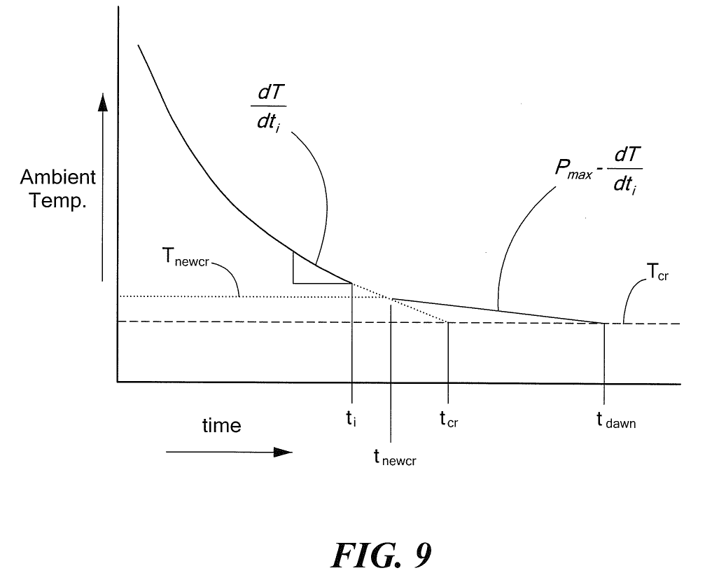

Referring briefly to FIG. 9, a graph includes a horizontal scale in units of real time in minutes and a vertical scale in units of ambient temperature in degrees Celsius. Curves on the graph are indicative of the case where the system heating capability is less than the environmental cooling rate, i.e., the heating rate cannot keep up with the cooling rate. With the RF power on, not all of the environmental cooling can be mitigated, so the environment continues to cool at a rate equal to the difference between the heating capability and cooling rate.

A curve labeled as dT/dtᵢ is indicative of the cooling rate before any RF power is turned on. A curve labeled as Pₘₐₓ−dT/dtᵢ is indicative of a difference between the heating rate and the cooling rate and is representative of a resulting cooling rate when the RF power is turned on. It will be recognized that it is desirable to turn on the RF power at a time t_{newer} early enough that the curve labeled as Pₘₐₓ−dT/dtᵢ remains at or above the critical temperature, T_{newer} until the time of dawn, t_{dawn}. The time of dawn can be calculated by the temperature processing module 80 based upon the real time signal 72a. It will also be recognized that if the RF power were not turned on, the ambient temperature would reach the critical temperature T_{cr} at a time t_{cr}, which is earlier than the time t_{dawn}.

Returning again to FIG. 2A, in some embodiments, the relative humidity processing module 78 can be configured to generate a processed relative humidity s signal 78a according to a relationship between the relative humidity(s) measured by the relative humidity sensors 64 and the predetermined crop-specific data values corresponding to the critical highest relative humidity value, RH_{cr}, within the predetermined crop-specific data values 88a. For example, in some embodiments, the relationship can be a difference of the form:

(RH_{Measured}−RH_{cr})

In one particular embodiment, RH_{cr} is equal to fifty percent.

In some embodiments, the above processed relative humidity s signal 78a can partially override the processed surface temperature signal 80a. For example, in some embodiments, when the above difference of relative humidities is greater than zero, the RF power can be turned on even when the processed temperature signal 78a does not so indicate.

In some embodiments, the wind speed processing module 84 can be configured to generate a processed wind speed signal 84a according to a relationship between the wind speed(s) measured by the wind speed sensors 68 and the predetermined crop-specific data values corresponding to the critical highest wind speed value, WS_{cr}, within the predetermined crop-specific data values 88a. For example, in one particular embodiments, the relationship can be a difference of the form:

(WS_{Measured}−WS_{cr})

In one particular embodiment, WS_{cr} is equal to three miles per hour.

In some embodiments, the above processed wind speed signal 84a can partially override the processed surface temperature signal 80a. For example, in some embodiments, when the above difference of wind speed is greater than zero, the RF power can be turned on even when the processed temperature signal 78a does not so indicate.

In some embodiments, the radiation processing module 84 can be configured to generate a processed radiation signal 82a according to a relationship between the radiation measured by the radiation sensor 70 and the predetermined crop-specific data values corresponding to the critical lowest radiation, R_{cr}, within the predetermined crop-specific data values 88a. For example, in one particular embodiment, the relationship can be a difference of the form:

(R_{Measured}−R_{cr})

In one particular embodiment, R_{cr} is equal to five hundred Watts per square meter.

In some embodiments, the above processed radiation signal 82a can partially override the processed surface temperature signal 80a. For example, in some embodiments, when the above difference of radiations is less than zero, the RF power can be turned on even when the processed temperature signal 78a does not so indicate.

The environmental data processing module 76 can include the combining module 86 coupled to receive the processed temperature signal 82a, and the power feedback signal 60a, and to control the RF power signal according to the processed temperature signal 82a and the power feedback signal 60a. In some embodiments, the combining module 86 is also coupled to receive at least one of the processed wind speed signal 84a, the processed relative humidity signal 78a, or the processed radiation signal 82a, and to control the RF power signal according to the processed temperature signal 82a and the power feedback signal 60a, and also according to at least one of the processed wind speed signal 84a, the processed relative humidity signal 78a, or the processed radiation signal 82a, in ways described above.

In one particular embodiment, the combining module 86 can use the real time clock signal 78a to anticipate when the crop temperature may tend to rise due to daylight hours, or when the crop temperature may tend to fall due to night time hours and adjust the power control signal 74a in order to anticipate the upcoming daylight or night time. In some embodiments, the power calculation module 74 includes a maximum threshold associated with the power of the RF signal 60b, and the power RF transmitter 60, or more particularly, the combining module 86, is configured to be able to exceed the threshold only during predetermined times, for example, at night.

The power control signal 74a can be generated according to the relationships above provided by the temperature processing module 80 as provided by the processed temperature signal 80a. In addition, the combining module 86 can be coupled to receive the power feedback signal 60a, which is indicative of output RF power generated by the RF transmitter 60. The combining module 86 can tailor the power control signal 74a also in accordance with the power feedback signal 60a.

In some embodiments, particularly above-described embodiments or situations for which the system heating capability equals or exceeds the environmental cooling rate, the power adjustment module 90 can provide proportional adjustment of the average power of the RF signal 60b as an adjustment of an on-off duty cycle of the RF signal 60b. In some other embodiments, the power adjustment module 90 can provide adjustment of the average power of the RF signal 60b as a continuously proportional adjustment of the power of the RF signal 60b in accordance with a continuously variable power control signal 74a.

In some embodiments, the power calculation module 74 is implemented as a computer having a computer readable storage medium therein. The computer readable storage medium can include instructions for implementing the above described operations of the temperature processing module 80, and, in some embodiments, at least one of the relative humidity processing module 78, the wind sped processing module 84, the radiation processing module 82, or the combining module 86. In some embodiments, data contents of the crop/system data repository 88 are stored on a local hard drive in the computer. In some other embodiments, data contents of the crop/system data repository 88 are stored on a hard drive of a remote server.

Referring now to FIG. 3, an exemplary RF radiator 100 can be the same as or similar to one of the RF radiators 52a-52f of FIG. 2. In one particular arrangement, the RF radiator 100 is a specially shaped disc-cone antenna, or another configuration (which is not limited to a disc cone), having a geometry designed to create a desired pattern. However, in other embodiments, a set of several discrete antennas of another configuration are used that, when combined, create the desired pattern. Furthermore, a downward angle of a formed beam can be generated by varying an operational frequency from a design frequency that would otherwise result in an omnidirectional pattern. To this end, a cone diameter, a height, a diameter, a cone angle, as well as the operational frequency can be selected.

The RF radiator 100 transmits RF energy into the air, which RF energy has a vertical beampattern about a vertical axis 102 and a horizontal axis 104. The vertical beampattern has a main lobe 106 azimuthally continuous about the vertical axis 102 as will be apparent from FIG. 4 below.

The main lobe 106 has a vertical beam angle 108 in the range of fifteen to eighty-five degrees from vertical. In one particular arrangement, the vertical beam angle 108 is about forty degrees. In one particular arrangement, the vertical beam angle 108 is about ninety degrees.

The main lobe 106 also has a vertical beamwidth 112 in the range of twenty to seventy degrees. In one particular embodiment, the vertical beamwidth 112 is selected so that a peak of the main lobe 106 is aimed directly at a base of the tower (e.g., 54a, FIG. 2) of an adjacent RF radiator.

The vertical beampattern can have sidelobes, of which a sidelobe 110 is representative. Sidelobe levels are of little concern because they contribute to the total heating effect at a power density low enough not to disrupt the uniform power distribution within the volume occupied by the crops. However, in one particular embodiment, power levels of the sidelobes are more than ten dB below the power level of the main lobe 106.

Referring now to FIG. 4, the main lobe 106 of the RF radiator 100 of FIG. 3 has a horizontal beampattern 122 shown about the horizontal axis 104 of FIG. 3 and about another horizontal axis 120. The horizontal beampattern 122 can be generally omnidirectional in azimuth.

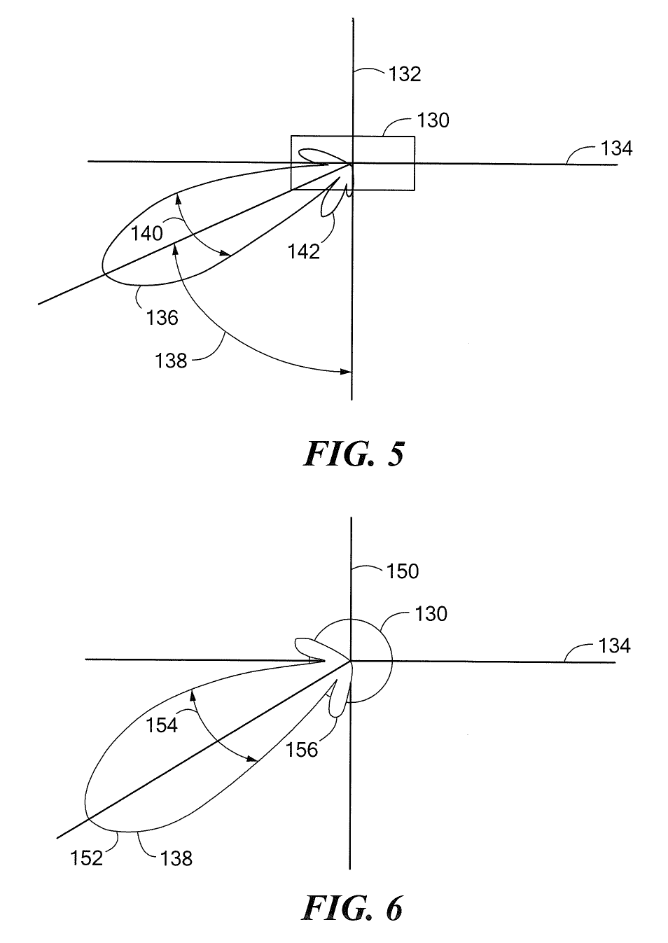

Referring now to FIG. 5, an RF radiator 130 can be the same as or similar to one of the RF radiators 52a-52f of FIG. 2. The RF radiator 130 can be a selected one of a corner reflector, a diagonal horn, or an axial mode helix antenna.

The RF radiator 130 transmits RF energy into the air, which RF energy has a vertical beampattern about a vertical axis 132 and a horizontal axis 134. The vertical beampattern has a main lobe 136.

The main lobe 136 has a vertical beam angle 138 in the range of fifteen to eighty-five degrees. In one particular arrangement, the vertical beam angle 138 is about forty degrees. In one particular arrangement, the vertical beam angle 108 is about ninety degrees.

The main lobe 136 also has a vertical beam width 140 in the range of twenty to seventy degrees. In one particular embodiment, the vertical beam width 140 is selected so that the directivity of the RF radiator 130 is about nine dB greater than that of a cone-dipole antenna.

The vertical beampattern can have sidelobes, of which a sidelobe 142 is representative. Sidelobe levels are of little concern. However, in one particular embodiment, power levels of the vertical sidelobes are more than ten dB below the power level of the main lobe 136.

Referring now to FIG. 6, the main lobe 136 of the RF radiator 130 of FIG. 5 has a horizontal beampattern having a main lobe 152 with a horizontal beam width 154. The horizontal beam width 154 can be in the range of about twenty to ninety degrees. In one particular arrangement, the horizontal beamwidth is about fifty-five degrees. As described above in conjunction with FIG. 5, the vertical beamwidths 140 (FIG. 5) and the horizontal beamwidth 154 are selected so that the directivity of the RF radiator 130 is about nine dB greater than that of a of a cone-dipole antenna.

The horizontal beampattern can have sidelobes, of which a sidelobe 156 is representative. Sidelobe levels are of little concern. However, in one particular embodiment, power levels of the horizontal sidelobes are more than ten dB below the power level of the main lobe 136.

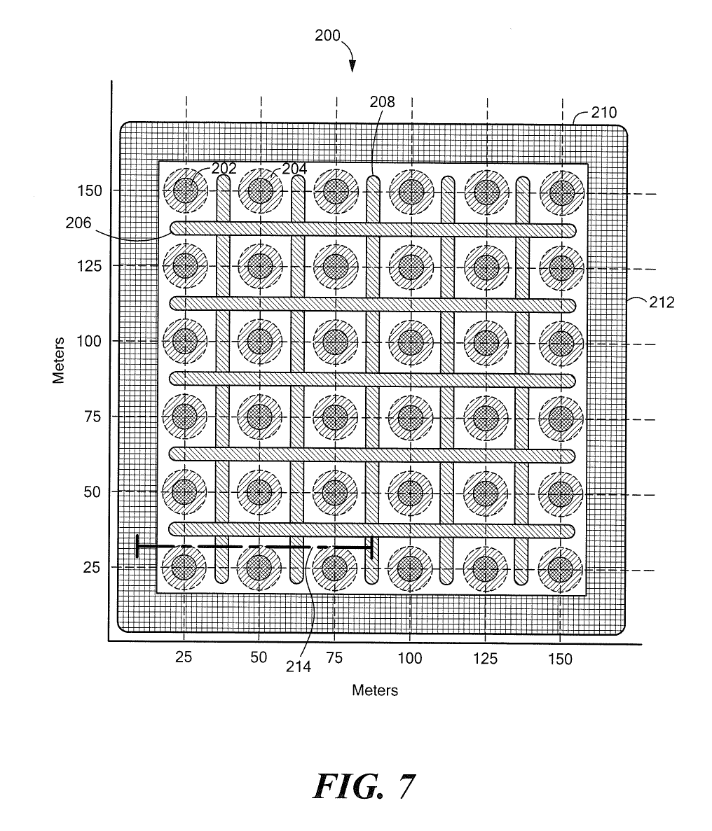

Referring now to FIG. 7, a top view of an exemplary system as shown, for example, in FIG. 2, is shown superimposed upon a graph 200. The graph 200 includes a vertical axis having units of meters and a horizontal axis having units of meters. It will be understood that the graph approximately corresponds to nine acres, which is about one hundred eighty by one hundred eighty meters.

The exemplary system includes four RF radiators per acre, of which an RF radiator 202 is representative, and each of a type described above in conjunction with FIGS. 2-4, having omnidirectional horizontal beampatterns of a type shown, for example, in conjunction with FIG. 4. At any particular height above an orchard of crop trees, the horizontal pattern of RF field strength about the orchard is represented by hatched regions. First regions, of which a region 204 is representative, have a first average RF power density. Second regions, of which regions 206 and 208 are representative, have a second average RF power density generally lower than the first average RF power density of the first regions (e.g., 204). However, in other embodiments, the second average RF power density of the second regions (e.g., 206 and 208) can be about the same as the first average RF power density of the first regions (e.g., 204).

Third regions, of which regions 210 and 212 are representative, have a third average RF power density also generally lower than the first average RF power density of the first regions (e.g., 204). In some arrangements, the average RF power density of the third regions 210, 212 can be about the same as the second RF power density of the second regions 206, 208.

The average RF power densities of the first, second and third regions all correspond to a particular height above the orchard and below the RF radiators (e.g., 202). For example, in one particular embodiment, the RF radiators (e.g., 202) are at a height of about six meters and the various regions are indicative of RF power densities at the top of crop trees at a height of about three meters.

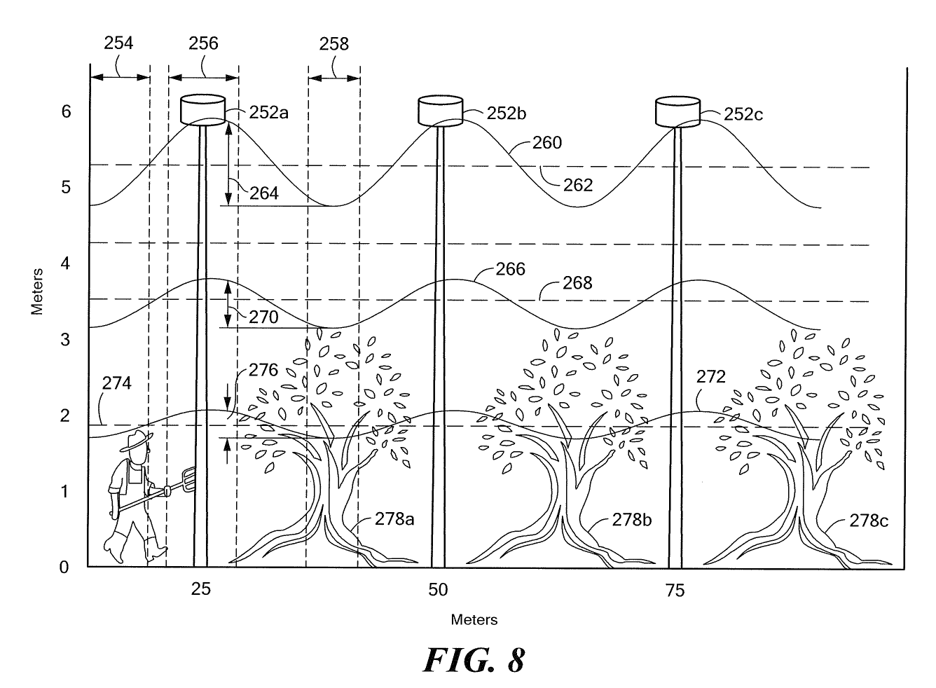

While the average RF power densities are shown to vary about the horizontal dimensions of the orchard, it will be understood from the discussion below in conjunction with FIG. 8 that by selecting a variety of system parameters, the average RF power densities about the horizontal dimensions can be uniform to a predictable and useful degree about the horizontal dimensions. Furthermore, it will be seen that the average power density in any horizontal plane within the volume occupied by the corps is relatively invariant between the planes.

While four RF radiators are shown per acre, in other arrangements, more than four or fewer than four RF radiators per acre can be used. In one particular embodiment, one RF radiator per acre is used. Radiators per acre can be in the range of one to sixteen. While the RF radiators are shown to be uniformly spaced, in other arrangements, the RF radiators are not uniformly spaced.

For reasons described more fully below in conjunction with FIG. 8, the number of RF radiators per acre can be selected to achieve a desired, i.e., relatively small, amount of peak-to-peak variation of RF power density at a predetermined height within and about the field. In some embodiments, the predetermined height at which this effect is achieved is about 2 meters, which is about the height of a person whom may be within the field.

While the regions 204-212 are indicative of field densities that may result from RF radiators having beampatterns of a type shown in FIGS. 3 and 4, it will be understood that, in other arrangements, some or all of the RF radiators can have beampatterns of a type shown in FIGS. 5 and 6.

Referring now to FIG. 8, a vertical slice 214 of part of the graph of FIG. 7 is shown as a graph 250, which includes a horizontal axis having units of meters, and a vertical axis having units of meters (height).

Three RF radiators 252a-252c each transmit RF energy having a beampattern described above in conjunction with FIGS. 3 and 4. Each one of the RF radiators 252a-252c is at a height of about six meters, which height is above the tops of crop trees 278a-278c in an orchard, which tops are at a height of about three meters. A first region 256 corresponds to one of the first regions (e.g., 202) of FIG. 7, a second region 258 corresponds to one of the second regions (e.g., 206) of FIG. 7, and third region 254 corresponds to one of the third regions (e.g., 210) of FIG. 7.

A curve 260 is indicative of RF power density near to the height of the RF radiators 252a-252c (at about six meters) versus vertical and horizontal position about the orchard when the RF radiators 252a-252c each transmit a power sufficient to result in a minimum RF power density in watts per square meter required to prevent freeze damage, for example, about five watts per square meter. An average RF power density 262 of the curve 260 is about five watts per square meter. A peak-to-peak variation 264 of the power represented by the curve 260 is relatively high.

A curve 266 is indicative of RF power density near to the tops of the crop trees 278a-278c (at about three meters) versus vertical and horizontal position about the orchard when the RF radiators 252a-252c each transmit the above-described power sufficient to result in a minimum RF power density in watts per square meter required to prevent freeze damage, for example, about five watts per square meter.

As describe above, it is desirable in some situations to provide about eighteen watts per square meter at the trees 278a-278c. However, other RF power densities are useful in some situations. Thus, an RF power density of about five watts per square meter is used as a typical example.

An average RF power density 268 of the curve 266 is about five watts per square meter, which is about the same as the average power density 262 at a greater height. The RF power density of the curve 266 has a peak-to-peak variation 270 less than the peak-to-peak variation 264 at greater heights near the heights of the RF radiators 252a-252c. It is desirable that the peak-to-peak variation 270 be as small as possible. In some arrangements the peak-to-peak variation 270 near to the tops of the trees 278a-278c is less than about ten percent of the average RF power density 268 near to the tops of the trees 278a-278c. However, in other arrangements, the peak-to-peak variation 270 near to the tops of the trees 278a-278c is within the range of one percent and fifty percent of the average RF power density 268 near to the tops of the trees 278a-278c.

A curve 272 is indicative of RF power density at the top (head) of a person 280 (at about two meters) versus vertical and horizontal position about the orchard when the RF radiators 252a-252c each transmit the above-described power sufficient to result in the minimum RF power density of about five watts per square meter.

An average RF power density 274 of the curve 272 is also about five watts per square meter, which is about the same as the average power densities 262, 268 at greater heights. A peak-to-peak variation 276 of the curve 272 is less than the peak-to-peak variation 264 at greater heights near the heights of the RF radiators 252a-252c and also less than the peak-to-peak variation 270 near the tops of the trees 278a-278c. For reasons described below, it is desirable that the peak-to-peak variation 276 be as small as possible. In some arrangements the peak-to-peak variation 276 near to the top of the person 280 is less than about ten percent of the average RF power density 274 near to the top of the person 280. However, in other arrangements, the peak-to-peak variation 276 near to the top of the person 280 is within a range of one percent and fifty percent of the average RF power density 274 near to the top of the person 280.

From the above discussion, it will be understood that, at heights below the RF radiators 252a-252c, the average power density along horizontal axes at different heights above the ground is relatively invariant. In the particular example above, the average RF power density is about five watts per square meter. It should also be understood that the peak-to-peak variation along horizontal axes tends to decrease at heights closer to the ground. The decreased peak-to-peak variation near the ground is a desirable outcome, since it is desirable to keep the RF power density near the ground, where people walk, as consistent as possible and under the IEEE safe exposure limits described above. Positive peaks in the RF power density, if they were large enough, could cause regions of unacceptably high energy density where people walk.

While the RF radiators 252a-252c are shown to be at a height of about six meters, in other arrangements, the RF radiators are at heights greater than or less than six meters. However, it will be appreciated that the horizontal peak-to-peak variation of the RF power density at a height of crops and at the height of people tend to become more uniform when the RF radiators are at greater heights, but at the expense of greater required transmit power from each RF radiator.

All references cited herein are hereby incorporated herein by reference in their entirety.

Having described preferred embodiments of the invention it will now become apparent to those of ordinary skill in the art that other embodiments incorporating these concepts may be used. Additionally, the software included as part of the invention may be embodied in a computer program product that includes a computer readable storage medium. For example, such a computer readable storage medium can include a readable memory device, such as a hard drive device, a CD-ROM, a DVD-ROM, or a computer diskette, having computer readable program code segments stored thereon. A computer readable transmission medium can include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A system for preventing freezing of crops within a volume, comprising:
a plurality of RF radiators configured to radiate RF energy into the volume, the RF energy having an RF frequency substantially absorbed by water, each one of the plurality of RF radiators having a respective beampattern with a respective vertical beam angle, a respective vertical beam width, and a respective horizontal beam width, wherein a respective height, a respective spacing, a respective output power, the respective vertical beam angle, the respective vertical beam width, and the respective horizontal beam width of each one of the plurality of RF radiators is selected to result in an average RF power density taken about three dimensions within the volume sufficient to prevent freezing of a substantial portion of the crops, and also to result in a peak-to-peak variation of RF power density taken about two dimensions in a horizontal plane within the volume and at heights below a predetermined height to be less than a predetermined percentage of an average RF power density taken about the two dimensions, and also to result in positive peaks of the peak-to-peak variation of the RF power density taken about the two dimensions at the heights below the predetermined height to have a magnitude below a safe level for human exposure.

2. The system of claim 1, wherein the predetermined height is about six feet and wherein the predetermined percentage is about ten percent.

3. The system of claim 1, wherein the average RF power density taken about two dimensions in any horizontal plane within the volume is at least eighteen watts per square meter.

4. The system of claim 1, wherein the average RF power density taken about the three dimensions within the volume is at least eighteen watts per square meter.

5. The system of claim 1, wherein the vertical beam angle is in the range of about fifteen to eighty-five degrees, wherein the vertical beam width is in the range of about twenty to seventy degrees, and wherein the horizontal beam width is in the range of about twenty to three hundred sixty degrees.

6. The system of claim 5, wherein RF radiators proximate to a side of the volume have smaller horizontal beamwidths than other ones of the plurality of radiators.

7. The system of claim 1, further comprising:
an RF transmitter coupled to each one of the plurality of RF radiators to provide an RF signal to each one of the plurality of RF radiators;
a power calculation module coupled to the RF transmitter; and
one or more environmental sensors coupled to the power calculation module to provide a respective one or more environmental signals, wherein the power calculation module is configured to process the one or more environmental signals to provide an adjustment of a power of the RF signal in accordance with the one or more environmental signals.

8. The system of claim 7, wherein the adjustment of the power of the RF signal results in the RF signal being on or off.

9. The system of claim 7, wherein the adjustment of the power of the RF signal is provided as an adjustment of a duty cycle of the RF signal.

10. The system of claim 7, wherein the adjustment of the power of the RF signal is provided as a continuously proportional adjustment of the power of the RF signal.

11. The system of claim 7, wherein the one or more environmental sensors comprise one or more temperature sensors, and wherein the one or more environmental signals comprise one or more environmental signals representative of a respective one or more temperatures proximate to the volume.

12. The system of claim 11, wherein the power calculation module provides the power of the RF signal in relation to a predetermined critical lowest temperature plus an offset temperature.

13. The system of claim 11, wherein the power calculation module provides the power of the RF signal in relation to a calculated critical lowest temperature proportional to a difference between a heating capability of the system and a rate of temperature drop of the ambient temperature within the volume and also proportional to a difference in time between the present time and a time at which dawn occurs proximate to the volume.

14. The system of claim 11, wherein the one or more temperature sensors comprise a plurality of temperature sensors.

15. The system of claim 12, wherein the one or more environmental sensors also comprise at least one sunlight radiation sensor, and wherein the one or more environmental signals also comprise an environmental signal representative of an intensity of sunlight radiation.

16. The system of claim 15, wherein the power calculation module provides the power of the RF signal also in relation to a difference between a predetermined sunlight intensity and a sunlight intensity represented by the one or more environmental signals.

17. The system of claim 12, wherein the one or more environmental sensors also comprise one or more wind speed sensors, and wherein the one or more environmental signals also comprise environmental signals representative of one or more wind speeds within the volume.

18. The system of claim 17, wherein the power calculation module provides the power of the RF signal also in relation to a difference between a predetermined wind speed and a wind speed represented by the one or more environmental signals.

19. The system of claim 12, wherein the one or more environmental sensors also comprise one or more relative humidity sensors, and wherein the one or more environmental signals also comprise one or more environmental signals representative of one or more relative humidities within the volume.

20. The system of claim 19, wherein the power calculation module provides the power of the RF signal also in relation to a difference between a predetermined relative humidity and a relative humidity represented by the one or more environmental signals.

21. The system of claim 11, further comprising:
a real time clock coupled to the power calculation module to provide a clock signal; wherein the power calculation module is configured to process the one or more environmental signals and to process the clock signal to provide an adjustment of a power of the RF signal in accordance with the one or more environmental signals and with the clock signal.

22. The system of claim 21, wherein the power calculation module includes a maximum threshold associated with the power of the RF signal, and wherein the RF transmitter is configured to be able to exceed the threshold only during predetermined times.

23. The system of claim 1, wherein the positive peaks of the peak-to-peak variation of the RF power density taken about the two dimensions at the heights below the predetermined height are less than about two milliwatts per square centimeter.

24. A method of warming crops within a volume, comprising:
irradiating the volume with RF energy, the RF energy having an RF frequency substantially absorbed by water, to result in an average RF power density taken about three dimensions within the volume sufficient to prevent freezing of a substantial portion of the crops, and also to result in a peak-to-peak variation of RF power density taken about two dimensions in a horizontal plane within the volume and at heights below a predetermined height to be less than a predetermined percentage of an average RF power density taken about the two dimensions, and also to result in positive peaks of the peak-to-peak variation of the RF power density taken about the two dimensions at the heights below the predetermined height to have a magnitude below a safe level for human exposure.

25. The method of claim 25, further comprising:
providing an RF signal;
receiving one or more environmental signals; and
adjusting a power of the RF signal in accordance with the one or more environmental signals.

26. The method of claims 25, wherein the one or more environmental signals comprise one or more environmental signals representative of a respective one or more temperatures proximate to the volume.

27. A computer-readable storage medium having computer readable code thereon for warming crops within a volume, the medium comprising instructions for:
receiving one or more environmental signals; and
generating a control signal to adjust a power of an RF signal in accordance with the one or more environmental signals.

28. The computer-readable storage medium of claim 27, wherein the one or more environmental signals comprise one or more environmental signals representative of a respective one or more temperatures proximate to the volume.

29. The computer-readable storage medium of claim 28, wherein the RF signal is configured to couple to a plurality of RF radiators configured to radiate RF energy into the volume, the RF energy having an RF frequency substantially absorbed by water, each one of the plurality of RF radiators having a respective beampattern with a respective vertical beam angle, a respective vertical beam width, and a respective horizontal beam width, wherein a height, a spacing, an output power, the vertical beam angle, the vertical beam width, and the horizontal beam width of each one of the plurality of RF radiators is selected to result in an average RF power density taken about three dimensions within the volume sufficient to prevent freezing of a substantial portion of the crops, and also to result in a peak-to-peak variation of RF power density taken about two dimensions in a horizontal plane within the volume and at heights below a predetermined height to be less than a predetermined percentage of an average RF power density taken about the two dimensions, and also to result in positive peaks of the peak-to-peak variation of the RF power density taken about the two dimensions at the heights below the predetermined height to have a magnitude below a safe level for human exposure.
